(19) United States
(12) Patent Application Publication
(10) Pub. No.: US 2010/0064872 A1
(43) Pub. Date: Mar. 18, 2010

(54) PRODUCT FENCE FOR FOOD SLICER

(76) Inventors: Anatoly Gosis, Palatine, IL (US); James C. Fournier, Gurnee, IL (US); Frank A. Bondarowicz, Park Ridge, IL (US)

Correspondence Address: THOMPSON HINE LLP;Intellectual Property Group, P.O Box 8801, DAYTON, OH, 45401-8801, US

(21) Appl. No.: 12/209,753

(22) Filed: Sep. 12, 2008

(51) Int. Cl. B26D 7/06; A47J 43/00; B26D 1/14

(52) U.S. Cl. 83/717; 99/538; 83/471

(57) ABSTRACT

A food slicer includes a support member having a base portion and an upstanding portion. A rotatable cutting blade is secured to the upstanding portion for slicing food product. A food product table is mounted for movement past the cutting blade for holding product while being sliced by the cutting blade. A product fence assists in holding and stabilizing food product during slicing. An inner side of the food product table includes multiple spaced apart slots and the product fence includes an inner side with at least one finger extending downward within one of the slots of the food product table. Elongate protrusions may be provided at the bottom of the product fence for seating within grooves on a food support surface of the food product table. A food contact wall surface of the fence may be angled away from the food contact location and an inner faced of the food contact wall may be angled away from a gage plate of the slicer.

### TECHNICAL FIELD

This application relates generally to food slicers and, more particularly, to a product fence for a food slicer.

### BACKGROUND

The basic design of both manual and automatic food slicers has proven to be quite effective and durable throughout the years. Food slicers are utilized to slice a number of food products such as meats, cheeses and the like in a variety of environments such as delicatessens, supermarkets, and restaurants to name a few. Food slicers generally handle a variety of products of different shapes, sizes, and textures and provide slices of different thicknesses.

Gravity food slicers with reciprocating food product tables typically have a feature called a “pusher” that engages the food product on its top surface or end opposite the slicing blade to assist in holding the food product and increase its stability during slicing and movement of the food product table. When a long piece of food product is to be sliced (such as a long salami or the like) pushers can be removed or rotated out of the way to enable slicing of the long food product.

For some food product, typically those with a “high aspect ratio” (tall and thin), a product fence can be used to hold and stabilize the food product during slicing. Product fences of various configurations are known.

Nonetheless, it would be desirable to provide a slicer with a product fence that includes features that facilitate both adjustability and stability.

### SUMMARY

In one aspect, a food slicer includes a support member having a base portion and an upstanding portion. A rotatable cutting blade is secured to said upstanding portion for slicing food product. A food product table is mounted for movement past the cutting blade for holding product while being sliced by said cutting blade. An adjustable gage plate is provided for varying thickness of slices cut by said cutting blade. A product fence assists in holding and stabilizing food product during slicing. The food product table includes a front side, a rear side, an inner side extending between the front side and rear side and positioned toward the gage plate and an outer side extending between the front side and rear side and spaced away from the gage plate. The inner side includes multiple slots spaced apart in front to rear direction of the food product table. The product fence includes an inner side with at least one finger extending downward within one of the slots of the food product table. The finger interacts with the slot to prevent the food product fence from moving relative to the food product table in the front to rear direction. The finger may also be configured to interact with the slot to prevent the food product fence from moving upward away from the food product table.

In another aspect, a food slicer includes a support member having a base portion and an upstanding portion. A rotatable cutting blade is secured to said upstanding portion for slicing food product. A food product table is mounted for movement past the cutting blade for holding product while being sliced by said cutting blade. A food support surface of the food product table generally defines a support surface plane. An adjustable gage plate varies thickness of slices cut by said cutting blade. A product fence assists in holding and stabilizing food product during slicing. The product fence includes a food contact wall having a surface facing toward the front of the food product table, and the surface is rearwardly angled in a bottom to top direction relative to a lateral plane extending perpendicularly from the support surface plane. The food contact wall may also include an inner face that is inclined to extend away from the gage plate to provide a spacing between the gage plate and the top of the inner face that is larger than a spacing between the gage plate and the bottom of the inner face.

In a further aspect, a product fence for a food slicer includes a rigid elongated body with an inner side, an outer side, a front side and a rear side, the inner side including at least one downwardly extending finger with a lower hook portion extending toward the outer side, a bottom portion of the elongated body having at least one elongated protrusion extending between the inner side and the outer side for seating within a groove on a support surface of a product table of a food slicer. The product fence may also include a food contact wall surface that is angled away from a plane extending perpendicular to a plane defined by the bottoms of the protrusions.

### BRIEF DESCRIPTION OF THE DRAWINGS

FIG. 1

### DETAILED DESCRIPTION

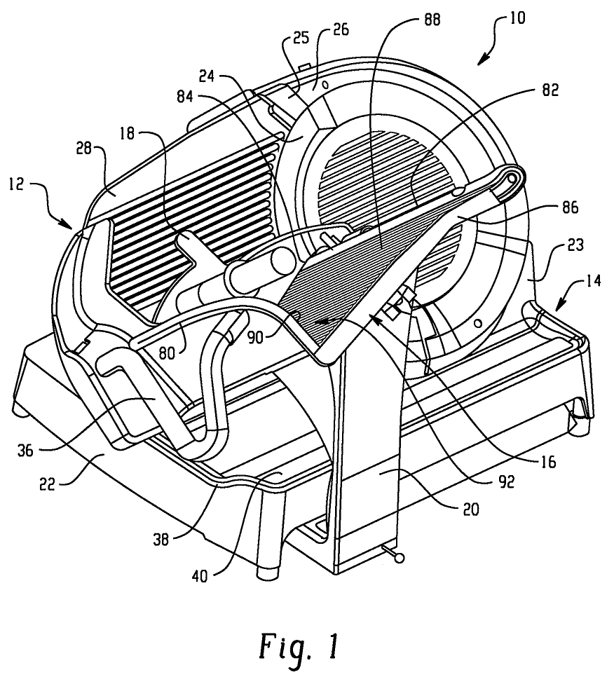

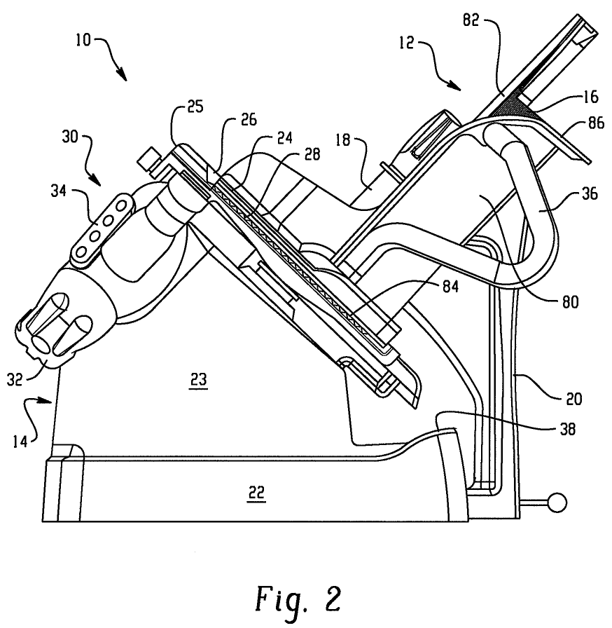

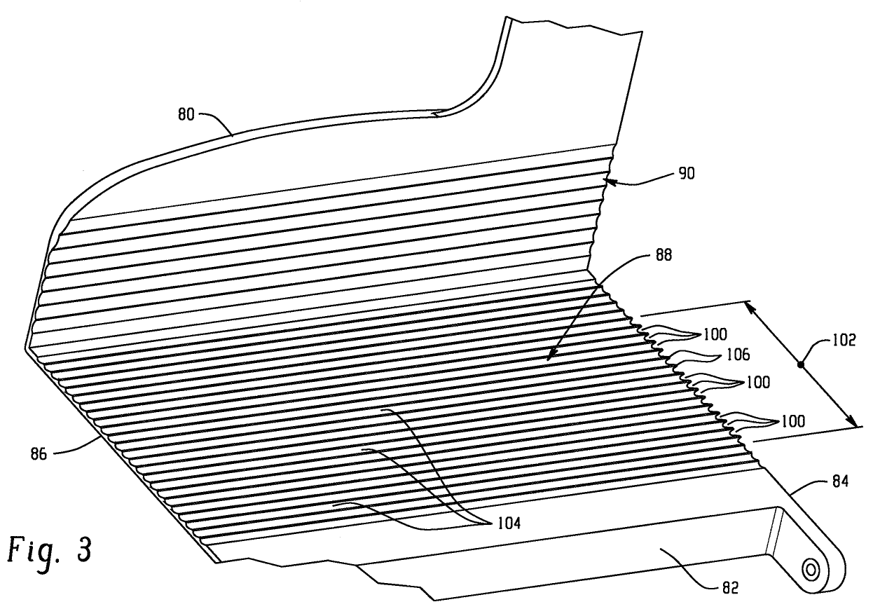

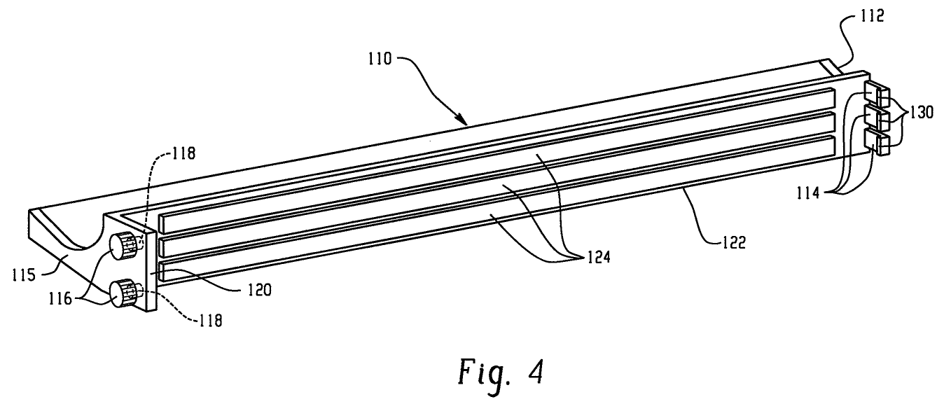

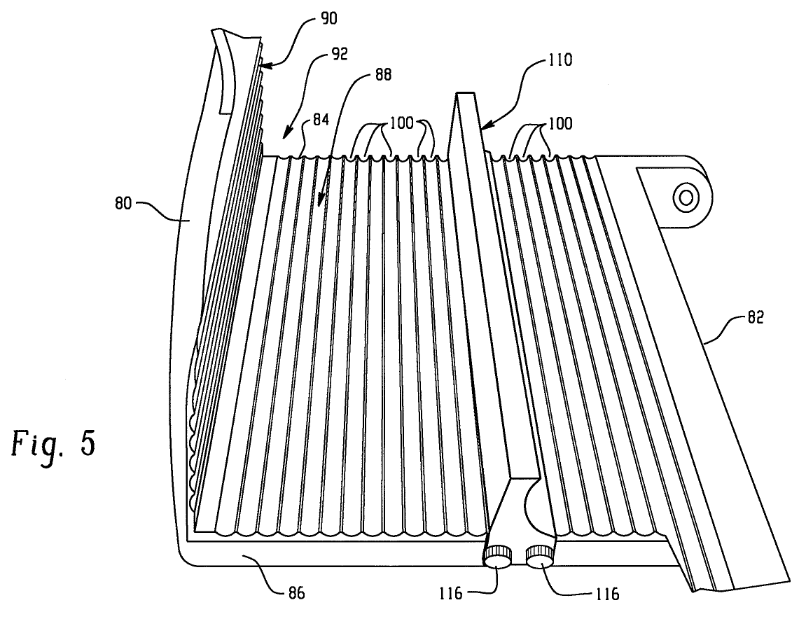

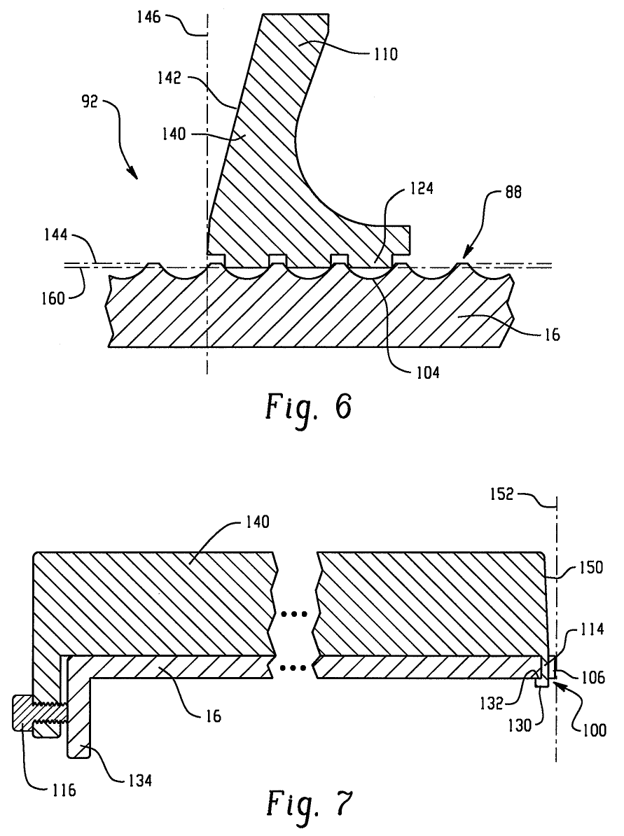

The food slicer is generally illustrated by numeral 10 of FIGS. 1-2 wherein like parts are designated by like reference numerals. Although the present disclosure will be described with reference to the example embodiments illustrated in the figures, it should be understood that the food slicer 10 may have many alternative forms without departing from the teachings of the present invention. One of ordinary skill in the art will additionally appreciate different ways to alter the parameters of the embodiments disclosed, such as the size, shape, or type of elements or materials, in a manner that falls within the spirit and scope of the present disclosure and appended claims.

FIGS. 1 and 2 illustrate the basic components of the food slicer 10, including a food handling portion generally illustrated by reference numeral 12 and a support portion, housing or member generally illustrated by reference numeral 14.

The food handling portion 12 substantially includes a product table 16, a push arm or pusher 18 and a product table support arm 20. The support portion 14 substantially includes a base portion or member 22, an upstanding portion or member 23, a rotating circular slicing knife or cutting blade 24, a ring guard 25, a knife cover 26, an adjustable gage plate 28 for determining slicing thickness and a control member or operator interface 30 having a gage plate support and adjustment mechanism 32 for the gage plate 28 and control buttons 34 as illustrated in FIG. 2.

The support portion 14 also includes at least one motor (not illustrated) positioned within the inside of the upstanding portion 23. If desired, a second motor (not illustrated) may be positioned within the inside of the support portion 14 along with associated structure for automatically moving the product table 16.

The product table includes a front side 80, a rear side 82, an inner side 84 positioned proximate the gage plate 28 and an outer side 86 spaced away from the gage plate. The product table includes a support surface 88 with an upwardly extending support wall 90 toward the front thereof.

Briefly, for manual slicing, a food product (not illustrated) is placed on the product table 16 beneath the pusher 18, and typically in a food product location 92 adjacent the wall 90, with the food product end to be cut or sliced resting upon the gage plate 28 with the product table 16 in its forward position. The operator adjusts the gage plate adjustment mechanism 32 which moves the gage plate 28 with respect to the blade 24 to provide a slice thickness gap therebetween that corresponds to the desired thickness for slicing of the product. The control buttons 34 are then accessed to turn the motor on which in turn rotates the blade 24.

The operator then pushes the product table 16 preferably via a handle 36 or other contact point toward the blade whereby the blade 24 slices the product to the desired thickness. The operator then pulls the product table 16 away from the blade for continued slicing of the product as described above. Automated reciprocal movement of the food product table may also be provided.

As FIG. 3 generally illustrates, the inner side of the product table 16 includes multiple slots 100 spaced apart in front to rear direction of the food product table, along a region 102 intended to be used for adjustment of product fence location. The slots extend downward through the surface 88 and, in the illustrated embodiment, are scallop-shaped and open at the inner edge of the surface, such that sideward table projections 106 separate the slots. Other slot configurations could be used, including fully enclosed slots. The support surface 88 includes multiple grooves 104 extending from the inner side 84 toward the outer side 86. In the illustrated embodiment each groove is in the form of a curved recess, but variations are possible.

Referring to FIG. 4, a product fence 110 includes an inner side 112 with one or more downwardly extending fingers 114 and an outer side 115 with one or more thumb screws 116 threaded within and extending through respective openings 118 in a downwardly extending outward portion 120 of the product fence. A bottom portion 122 of the elongated body of the product fence includes one or more elongated protrusions 124. The illustrated shape of the protrusions is generally rectangular, but variations are possible. The spacing between the protrusions is set to match the spacing between the grooves 104 of the upper surface 88 of the food product table so that the protrusions can seat within the grooves during fence mounting to the product fence.

In this regard, referring to FIGS. 5-7, the product fence 110 is mounted to the food product table with the projections 124 seated in respective grooves 104 of the surface 88. This interaction aids in inhibiting displacement of the product fence (e.g., to the left or right in FIG. 6). The product fence fingers 114 extend downward within respective table slots 100 and include respective hook portions 130 extending toward the outer side of the food product table and engaged with a lower edge portion 132 of the inner side of the food product table. This interaction between the fingers and the table aids in preventing the product fence from moving upward away from the surface 88 of the table (e.g., up and down in FIG. 7). The inward end of the thumb screw 116 at the outer side 115 of the product fence abuts against a downwardly extending edge portion 134 of the product table, thus pushing the product fence toward the outer side of the food product table (e.g., to the left in FIG. 7) so that the hook portions 132 are maintained beneath the lower edge portion 132 during slicer operation. Note that the sideward table projections 106 extend slightly past the ends of the fingers 114 to aid in assuring clearance relative to the gage plate and slicer knife.

To move the product fence, the thumb screw 116 is rotated to be backed off slightly from the downwardly extending edge portion 134, which then allows the product fence to move toward the gage plate side of the food product table (e.g., to the right in FIG. 7) far enough so that the hook portions clear the lower edge portion 132. The fence may then be moved upward away from the table surface 88, and repositioned as desired with the fingers 114 in a different set of slots 100 of the food product table. The thumb screw 116 is then rotated to again abut the lower edge portion 134, which again pulls the product fence outward so that the hook portions 130 engaged the lower edge portion 132. The product fence can also be removed entirely from the table for cleaning.

Referring to FIG. 6, the product fence includes a food contact wall 140 having a surface 142 facing toward the front of the food product table. The surface 142 is angled, from bottom to top, away from the food product location 92 of the food product table. Specifically, the food support surface 88 of the food product table generally defines a support surface plane 144. The fence surface 142 is rearwardly angled in a bottom to top direction relative to a lateral plane 146 extending perpendicularly from the support surface plane 144. This configuration of the fence surface 142 facilitates contact with the food product lower along the fence to reduce tipping forces applied to the fence by the food product during slicer operation. This feature is most effective when slicing food products of rectangular cross-section (e.g., many cheeses), but even in the case of food products of circular cross-section, the angle of the surface 142 at the point of contact with the food product will reduce the tipping force because some of the force will be directed downward toward the table surface 88. Plane 146 also extends perpendicularly to a bottom surface plane 160 that is defined by the bottoms of the protrusions 124.

Referring to FIG. 7, the upwardly extending wall 140 has an inner face 150 that is inclined to extend away from the gage plate (represented by plane 152) to provide a spacing between the gage plate and the top of the inner face that is larger than a spacing between the gage plate and the bottom of the inner face. This configuration helps prevent product jamming during slicing operations.

It is to be clearly understood that the above description is intended by way of illustration and example only, is not intended to be taken by way of limitation, and that various changes and modifications are possible.

What is claimed is:

1. A food slicer, comprising:
a support member having a base portion and an upstanding portion;
a rotatable cutting blade secured to said upstanding portion for slicing food product;
a food product table mounted for movement past the cutting blade for holding product while being sliced by the cutting blade;
an adjustable gage plate for varying thickness of slices cut by said cutting blade; and
a product fence for assisting in holding and stabilizing food product during slicing;
wherein said food product table includes a front side, a rear side, an inner side extending between the front side and rear side and positioned toward the gage plate and an outer side extending between the front side and rear side and spaced away from the gage plate, the inner side includes multiple slots spaced apart in front to rear direction of the food product table;
wherein the product fence includes an inner side with at least one finger extending downward within one of the slots of the food product table, the finger interacting with the slot to prevent the food product fence from moving relative to the food product table in the front to rear direction.

2. The food slicer of claim 1 wherein the finger also interacts with the slot to prevent the food product fence from moving upward away from the food product table.

3. The food slicer of claim 2 wherein the finger includes a hook portion extending toward the outer side of the food product table and engaged with a lower edge portion of the inner side of the food product table.

4. The food slicer of claim 3 wherein the outer side of the food product table includes a downwardly extending edge portion, the product fence includes a movable member that pushes against an outer face of the downwardly extending edge portion to hold the hook portion in engagement with the lower edge portion.

5. The food slicer of claim 4 wherein the movable member is adjustable to allow the product fence to be moved toward the inner side of the food product table so as to release engagement between the hook portion and the lower edge portion enabling the finger to move upward out of the slot for repositioning of the product fence on the food product table.

6. The food slicer of claim 5 wherein the movable member is a thumb screw threaded within and extending through a downwardly extending outward portion of the product fence.

7. The food slicer of claim 1 wherein the multiple slots are open toward the inner side of the food product table.

8. The food slicer of claim 1 wherein an upper surface portion of the food product table includes multiple grooves extending from the inner side toward the outer side, the product fence includes a bottom portion with at least one elongated protrusion seated in one of the grooves of the surface portion to aid in inhibiting displacement of the product fence.

9. The food slicer of claim 8 wherein the product fence includes a food contact wall having a surface facing toward the front of the food product table, the surface angled, from bottom to top, away from a food product location of the food product table.

10. The food slicer of claim 9 wherein the upwardly extending wall has an inner face that is inclined to extend away from the gage plate to provide a spacing between the gage plate and the top of the inner face that is larger than a spacing between the gage plate and the bottom of the inner face.

11. A food slicer, comprising:
a support member having a base portion and an upstanding portion;
a rotatable cutting blade secured to the upstanding portion for slicing food product;
a food product table mounted for movement past the cutting blade for holding product while being sliced by the cutting blade, a food support surface of the food product table generally defining a support surface plane;
an adjustable gage plate for varying thickness of slices cut by the cutting blade; and
a product fence for assisting in holding and stabilizing food product during slicing, the product fence includes a food contact wall having a surface facing toward the front of the food product table, the surface is rearwardly angled in a bottom to top direction relative to a lateral plane extending perpendicularly from the support surface plane.

12. The food slicer of claim 11 wherein the food contact wall has an inner face that is inclined to extend away from the gage plate to provide a spacing between the gage plate and the top of the inner face that is larger than a spacing between the gage plate and the bottom of the inner face.

13. A product fence for a food slicer, comprising:
a rigid elongated body with an inner side, an outer side, a front side and a rear side, the inner side including at least one downwardly extending finger with a lower hook portion extending toward the outer side, a bottom portion of the elongated body having at least one elongated protrusion extending between the inner side and the outer side for seating within a groove on a support surface of a product table of a food slicer.

14. The product fence of claim 13 wherein the bottom portion includes multiple elongated protrusions and the elongated body includes a food contact wall surface that is angled away from a plane extending perpendicular to a plane defined by the bottoms of the elongated protrusions.
